(19) United States
(12) Patent Application Publication
(10) Pub. No.: US 2002/0126506 A1
(43) Pub. Date: Sep. 12, 2002

(54) Hanging mistlettoe ornament

(76) Inventor: Mary Dianne Syme, New Castle, IN (US)

Correspondence Address: BRINKS HOFER GILSON & LIONE, ONE INDIANA SQUARE, SUITE 2425, INDIANAPOLIS, IN, 46204, US

(21) Appl. No.: 10/093,188

(22) Filed: Mar. 7, 2002

Related U.S. Application Data
(60) Provisional application No. 60/274,187, filed on Mar. 8, 2001.

(51) Int. Cl. F21S 4/00

(52) U.S. Cl. 362/567

(57) ABSTRACT

A hanging mistletoe ornament is disclosed that includes a spherical shell that may be comprised of two interconnected portions. A control unit is mounted in the shell, wherein the control unit is preferentially pre-programmed to include a song. A speaker is connected to the shell and the control unit for playing said song. A motion sensor is connected to the outer surface of the shell and the control unit for generating a signal that is sent to the control unit if motion is detected by the motion sensor, wherein the control unit plays the song in response to the signal from the motion sensor. A lighted display is also connected to the control unit and the outer surface of the shell, wherein the control unit illuminates the lighted display in response to the signal from the motion sensor.

### FIELD OF THE INVENTION

The present invention relates generally to holiday ornaments and more particularly, to a hanging mistletoe ornament that illuminates a predetermined lighted display and plays a song if motion is detected near the hanging mistletoe ornament.

### BACKGROUND OF THE INVENTION

Holiday ornaments having a generally circular cross-section are well known. Among these are the popular hollow, spherical or globular devices adapted to be suspended from a tree limb or the like and which comprise a usually opaque member of either a frangible glass-like substance or which may be constructed of plastics. In either instance, any enhanced ornamentation is limited to coloring of the material of the device or, the application of various designs thereto. Alternatively, the body of the device may be molded in a manner to produce three-dimensional male or female formations.

Alteration of the above described most common types of ornaments have included the use of an inflatable spherical member as well as the introduction of disparate elements into the hollow interior thereof. An example of a hollow Christmas tree ball or ornament containing a figurine therein can be found in German Pat. No. 850,793 issued Sep. 29, 1951 to Schmidt and which discloses a spherical ball formed of two transparent semi-spherical sections interlocked together after the suspension of a figurine therein.

U.S. Pat. No. 3,035,162 issued to Emmich on May 15, 1962 illustrates a Christmas tree ornament depicting a spherical member that includes a design figure embossed thereupon. The rigid member is transparent and contains white flocculent material representative of snow such that when a source of pressurized air is introduced at the bottom of the member, this material is projected upwardly within the hollow interior.

Mistletoes are another commonly used decoration item during the holiday season. Mistletoes are typically hung under doors or various other entryways in homes or buildings. When someone walks under the mistletoe, tradition has it that the person standing under the mistletoe is supposed to get a kiss from someone in the room, preferentially the husband, wife, boyfriend, girlfriend or some other significant other of the person standing under the mistletoe. Existing mistletoes that are traditionally used simply consist of a plastic plant that is formed in the shape of a mistletoe plant. Unfortunately, most of the time people don't even notice these mistletoes hanging from doors or entryways because they are not as noticeable as other holiday decorations that usually are placed up during the holiday season. To that end, a need exists for a hanging mistletoe ornament that can be used during the holiday season that draws attention to the person standing under the mistletoe.

### SUMMARY OF THE INVENTION

The present invention discloses a hanging mistletoe ornament that lights up and plays a song if triggered by motion. The preferred hanging mistletoe ornament includes a shell, which is preferably formed spherical in shape. A control unit is mounted in the shell for controlling operation of the electronic components of the hanging mistletoe ornament. In addition, the control unit is preferentially preprogrammed with a song stored within its internal memory. However, an external song storage device may be used to store the song in alternative embodiments of the present invention.

A speaker is connected to the shell and the control unit for playing the song. The shell preferentially includes a plurality of small apertures or one large aperture where the speaker is mounted to allow the sound generated from the speaker to freely pass into the surrounding environment. A motion sensor is connected to the outer shell and the control unit for generating a signal that is sent to the control unit if motion is detected by the motion sensor. In response to this signal from the motion sensor, the control unit plays the song. Preferentially, the song is a short jingle that is written and designed to obtain a kiss from someone near the person standing under the hanging mistletoe ornament.

In the preferred embodiment, a lighted display is also connected to the control unit and the outer surface of the shell. During operation, the control unit illuminates the lighted display in response to the signal from the motion sensor. The preferred lighted display is shaped to say KISS ME. As such, if someone walks under the hanging mistletoe ornament, the hanging mistletoe ornament will illuminate the lighted display and begin playing the song, which will attract attention to the person standing under the hanging mistletoe ornament.

Further objects and advantages of the present invention will be apparent from the following description, reference being made to the accompanying drawings wherein preferred embodiments of the present invention are clearly shown.

### BRIEF DESCRIPTION OF THE DRAWINGS

FIG. 1 is a perspective illustration of the preferred hanging mistletoe ornament constructed in accordance with the principles of the present invention.

FIG. 2 illustrates a block diagram of the electronic components of the preferred hanging mistletoe ornament.

FIG. 3 illustrates a block diagram of the electronic components of the preferred hanging mistletoe with fiber optic light transmitters used for the lighted display.

### DETAILED DESCRIPTION OF THE PRESENTLY PREFERRED EMBODIMENT OF THE INVENTION

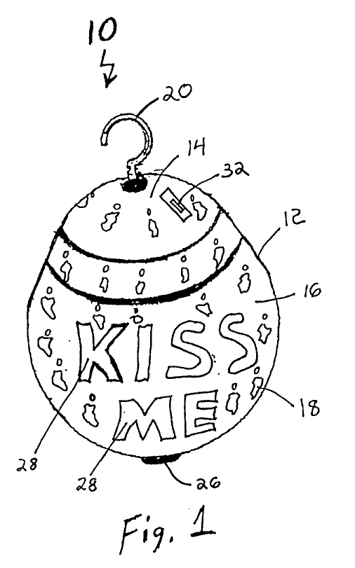

Referring to FIG. 1, a perspective view of a hanging mistletoe ornament 10 constructed in accordance with the principles of the present invention is illustrated. As depicted, the preferred hanging mistletoe ornament 10 includes a spherical shell 12 that is comprised of a first portion 14 and a second portion 16. The first portion 14 and the second portion 16 are preferentially friction fit together to form the spherical shell 12. Making the spherical shell 12 from two interconnectable portions allows the spherical shell 12 to be taken apart to provide access to the inner portion of the spherical shell 12.

The spherical shell 12 is preferably made from plastic or some other equivalent material. Further, the outer surface of the shell 12 is preferentially decorated with a plurality of mistletoe illustrations 18 or some other decorative artwork. A hook 20 may also be connected to the top portion of the shell 12 so that the hanging mistletoe ornament 10 can be readily hung from doorways or entryways and the like. Those skilled in the art would recognize that other shell shapes exist and may be used in the present invention and that the formation of the shell 12 in a spherical shape is by way of example only.

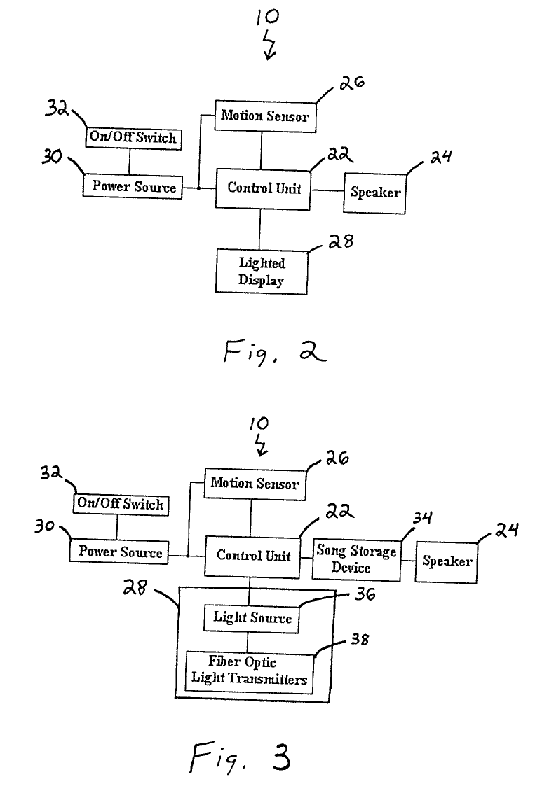

Referring to FIGS. 1 and 2, a more detailed description of how the hanging mistletoe ornament 10 operates is set forth below. As illustrated in FIG. 2, the preferred hanging mistletoe ornament 10 includes a control unit 22, a speaker 24, a motion sensor 26, a lighted display 28, a power source 30 and a switch 32. In the preferred embodiment of the present invention, the control unit 22 is mounted inside the shell 12 and is connected to the speaker 24, which is also mounted inside the shell 12. Although not illustrated, the shell 12 preferentially includes a plurality of small apertures where the speaker 24 is mounted to allow the sound generated from the speaker 24 to freely pass into the surrounding environment.

The preferred control unit 22 of the hanging mistletoe ornament 10 includes a memory storage area that is pre-programmed with a song during manufacturing. Preferentially, the song is a jingle that is written to attract a person to kiss a person standing under the hanging mistletoe ornament 10. Those skilled in the art would recognize that words or other sounds could be replaced with the song. As further illustrated in FIGS. 1 and 2, the control unit 22 is also connected to the motion sensor 26. The sensing portion of the motion sensor 26 is preferentially mounted on the outside of the shell 12 facing downward so that when someone passes under the banging mistletoe ornament 10, a signal is generated from the motion sensor 26 that is sent to the control unit 22. In response to the signal from the motion sensor 26, the control unit 22 is designed to begin playing the song stored within its internal memory through the speaker 24.

As further illustrated in FIGS. 1 and 2, the preferred hanging mistletoe ornament 10 also includes the lighted display 28, which is connected to the control unit 22 and preferentially mounted on the outer surface of the shell 12. During operation, when motion is detected by the motion sensor 26, the control unit 22 illuminates the lighted display 28. The control unit 22 can be programmed to constantly illuminate the lighted display 28 or pulse the lighted display 28. As illustrated in FIG. 1, preferentially the lighted display 28 is formed to say KISS ME. Although not illustrated, in the embodiment depicted in FIG. 2, the preferred lighted display 28 includes a light-emitting diode that illuminates the lighted display 28.

In the preferred embodiment, the power source 30 of the hanging mistletoe ornament 10 is connected to the control unit 22 and the motion sensor 26. As known in the art, the power source 30 is used to provide power to the electronic components of the hanging mistletoe ornament 10. In the preferred embodiment, the power source 30 comprises a battery that can be replaced as it loses its charge. The switch 32 is connected to the power source 30 and is used to turn the hanging mistletoe ornament 10 on and off.

Referring to FIG. 3, another preferred embodiment of the hanging mistletoe ornament 10 is illustrated. In this embodiment, the control unit 22 is connected to a song storage device 34 that is connected to the speaker 24. As such, the control unit 22 is not pre-programmed with the song in this embodiment, but the song is stored in a song storage device 34 that is connected to and controlled by the control unit 22. The preferred song storage device 34 comprises an integrated circuit that is capable of generating an output signal to drive the speaker 24 in response to a signal from the control unit 34. Although not illustrated in FIG. 3, the song storage device 34 may also be connected to the power source 30 if necessary.

In addition, in the embodiment illustrated in FIG. 3, the lighted display 28 includes a light source 36 and a plurality of fiber optic light transmitters 38. The light source 36 is connected to the control unit 22, which causes the light source 36 to illuminate in response to a signal from the motion sensor 26. When the light source 36 is illuminated, the light generated from the light source 36 is transferred to the tips of the fiber optic light transmitters 38. The tips of the fiber optic transmitters 38 are preferentially attached to the outside of the shell 12 to form the words KISS ME in the preferred embodiment of the present invention. However, those skilled in the art would recognize that other words could be used.

While the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A hanging mistletoe ornament, comprising:
a shell;
a control unit mounted in said shell, wherein said control unit is preprogrammed to include a predetermined sound stored in memory;
a speaker connected to said shell and said control unit for playing said sound; and
a motion sensor connected to said outer shell and said control unit for generating a signal that is sent to said control unit if motion is detected by said motion sensor, wherein said control unit plays said sound in response to said signal from said motion sensor.

2. The hanging mistletoe ornament of claim 1, wherein said sound comprises a song.

3. The hanging mistletoe ornament of claim 1, further comprising a lighted display connected to said control unit and the outer surface of said shell, wherein said control unit illuminates said lighted display in response to said signal from said motion sensor.

4. The hanging mistletoe ornament of claim 3, wherein said lighted display is shaped to say KISS ME.

5. The hanging mistletoe ornament of claim 3, wherein the light from said lighted display is generated from a light emitting diode connected to said control unit.

6. The hanging mistletoe ornament of claim 3, wherein said predetermined lighted display is generated from a plurality of fiber optic light transmitters that are illuminated by a light source connected to said control unit.

7. The hanging mistletoe ornament of claim 1, wherein said shell comprises a first portion and a second portion that are connected together to form said spherical shell.

8. A hanging mistletoe ornament, comprising:
a spherical shell;
a control unit mounted within said spherical shell including a pre-programmed sound stored in memory;
a speaker connected to said spherical shell and said control unit for playing said sound;
a motion sensor connected to said outer shell and said control unit for generating a signal that is sent to said control unit if motion is detected in the proximity of said hanging ornament, wherein said control unit plays said sound in response to said signal from said motion sensor; and
a lighted display connected to said control unit and mounted on said spherical shell, wherein said control unit illuminates said lighted display in response to said signal from said motion sensor.

9. The hanging mistletoe ornament of claim 8, wherein said pre-programmed sound is a song.

10. The hanging mistletoe ornament of claim 8, wherein said lighted display is shaped to say KISS ME.

11. The hanging mistletoe ornament of claim 8, wherein the light from said lighted display is generated from a light emitting diode connected to said control unit.

12. The hanging mistletoe ornament of claim 8, wherein said predetermined lighted display is generated from a plurality of fiber optic light transmitters that are illuminated by a light source connected to said control unit.

13. The hanging mistletoe ornament of claim 8, wherein said spherical shell comprises a first portion and a second portion that are removably fastened together to form said spherical shell.

14. A hanging mistletoe ornament, comprising:
a spherical shell;
a control unit mounted inside said spherical shell;
a sound storage device connected to said control unit, wherein said sound storage device stores a predetermined sound;
a speaker connected to said sound storage device for playing said sound;
a motion sensor connected to the outside of said spherical shell and said control unit for generating a signal that is sent to said control unit if motion is detected by said motion sensor, wherein said control unit causes said sound storage device to play said sound in response to said signal from said motion sensor.

15. The hanging mistletoe ornament of claim 14, wherein said sound comprises a song.

16. The hanging mistletoe ornament of claim 14, further comprising a lighted display mounted on the outside of said spherical shell and connected to said control unit, wherein said control unit illuminates said lighted display in response to said signal from said motion sensor.
